(19) United States
(12) Patent Application Publication
(10) Pub. No.: US 2004/0122754 A1
(43) Pub. Date: Jun. 24, 2004

(54) Methods and apparatus for processing check transactions in self service customer checkout terminals

(75) Inventor: Harden Evans Stevens III, Lexington, SC (US)

Correspondence Address: PAUL W. MARTIN, LAW DEPARTMENT, WHQ-4, 1700 S. PATTERSON BLVD., DAYTON, OH, 45479-0001, US

(73) Assignee: NCR Corporation, Dayton, OH (US)

(21) Appl. No.: 10/324,554

(22) Filed: Dec. 20, 2002

(51) Int. Cl. G06F 17/60

(52) U.S. Cl. 705/35; 705/42

(57) ABSTRACT

Systems and techniques for managing check payments in self service transactions are described. A self service terminal accepts inputs from a customer to conduct a transaction and, upon an appropriate selection from a customer, accepts a check from the customer in settlement of the transaction. The terminal reads magnetically encoded information from the check, captures an image of the check and prepares a check record including the check information, transaction amount and check image. The terminal transmits the check record to a cashier at a remote cashier station. The cashier may use the check record, including the check image, to determine whether to approve or disapprove the transaction.

### FIELD OF THE INVENTION

The present invention relates generally to improvements in retail transaction processing. More particularly, the invention relates to advantageous systems and techniques for processing checks presented as payment in retail transactions conducted at self service terminals.

### BACKGROUND OF THE INVENTION

Self service checkout terminals are increasing in popularity, and can help retailers to achieve significant savings in labor costs. In a typical configuration of self service terminals, a cashier monitors a number of self service terminals while stationed at a cashier terminal that receives information relating to transactions being carried out at each of a number of self service terminals. A single cashier may monitor transactions being carried out simultaneously at four, eight or more terminals and is able to review transaction information relayed to the cashier station from the terminals. Transaction information may include amounts due and tendered, customer requests for assistance, notifications that tender of payment is not being accepted, and the like. In addition, the terminals may transmit information relating to security matters. For example, as an item is entered into a transaction, it is typically placed into a shopping bag located on a scale that is part of the terminal. If there is a mismatch between the actual weight registered on the scale and the expected weight of products entered into the transaction, the cashier may be notified. In addition, the terminals may include security cameras which relay a video feed to the cashier station. The cashier may then watch the video feed in order to detect fraud.

In typical prior art terminals, cash transactions, debit card transactions and credit card transactions can be accomplished without intervention by a cashier. However, when a customer wishes to tender a check for payment, the check must be presented to the cashier, so that the cashier can make sure that the check has been properly filled out, and can also examine the customer's identification. A typical paper check, especially one that is presented as part of an in person retail transaction, is handwritten. It is possible for a terminal to be designed and programmed so as to complete a blank check inserted by the customer with a date, payee name and amount, but the check will need to be signed by the customer in order to be valid and the signature can be expected to be handwritten. Typical self service terminals are not able to determine if a handwritten check is filled out and signed properly, so that if customers were allowed to present a handwritten check at a self service terminal, with no cashier intervention, a customer might be tempted to fail to sign the check, to write the check for a smaller amount than that actually due, or to commit other fraudulent acts.

Therefore, if a customer wishes to present a check in order to complete a transaction, he or she must summon the cashier or must bring the check to the cashier station in order to allow the check to be inspected and processed by the cashier. The need to present a paper check to the cashier increases the demands on the cashier's time and diminishes the efficiency of the self service checkout process. There exists, therefore, a need for a self service terminal that will allow a customer to present a paper check without requiring physical presentation of the check to a cashier.

### SUMMARY OF THE INVENTION

To advantageously address this need, as well as provide other substantial benefits as described in greater detail below, a self service terminal according to an aspect of the present invention may suitably a customer interface allowing the customer to conduct a transaction by entering commands and making selections, entering product information and submitting payment. The customer interface may suitably include a display, which may operate as a touch screen display, a scanner for scanning product bar codes and various devices for accepting and dispensing cash and for reading financial information. The terminal also includes a check processor operative to read information from a check tendered by a customer and to construct a check record including information relevant to deciding whether or not to accept the check in settlement of the transaction. The check record preferably includes an image of the check.

The check record may be transmitted to a cashier at a location preferably remote from the terminal, allowing the cashier to examine the check record. The examination may include examination of the image of the check, for example to determine if the check is authentic and has been properly filled out and signed. The check record may include additional information, such as a number and image of an identification document and a customer record indicating whether or not the customer has previously tendered bad checks. It is also possible for the terminal to submit check information to a clearinghouse to determine whether the customer's account contains the necessary funds and to include a note as to the sufficiency or insufficiency of funds in the check record.

The collection of check information and the transmittal of the check record to a cashier at a remote location allow a single cashier to monitor check transactions at a number of terminals without a need to directly interact with the customers using the terminals.

Once the cashier has approved the transaction, the terminal can process the check for payment and return the check to the customer. Alternatively, the terminal can retain the check for later pickup and deposit to a bank or submission to a clearinghouse.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a self service checkout terminal according to an aspect of the present invention;

FIG. 2 illustrates a self service checkout system according to an aspect of the present invention; and

FIGS. 3A and 3B illustrate a process of self service transaction processing according to an aspect of the present invention.

### DETAILED DESCRIPTION

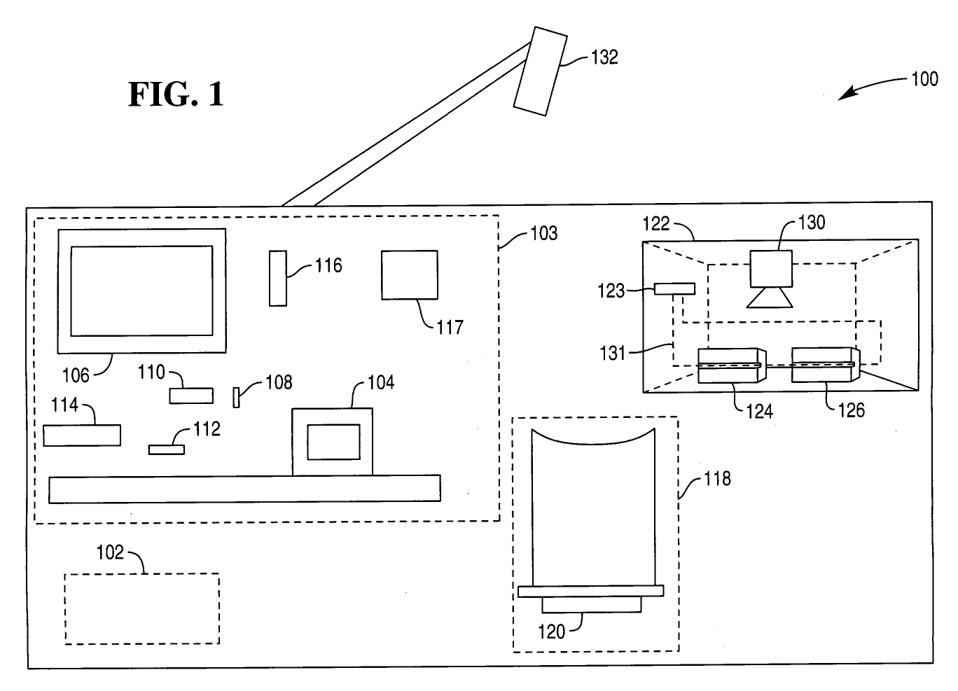

FIG. 1 illustrates a self service terminal 100 according to an aspect of the present invention. The terminal 100 includes a computer 102 and a customer interface 103. The customer interface 103 may suitably include a scanner 104, as well as a display 106. The display 106 may suitably be operable as a touch screen display. Alternatively, a display similar to the display 106 may be used, but without touch screen capability. In such a case, a keyboard or keypad (not shown) may accompany the display. The customer interface 103 also includes a coin acceptor 108, bill acceptor 110, coin return 112, bill return 114, financial card reader 116 and printer 117.

The terminal 100 also includes a bagging area 118 including a scale 120. The scale 120 sends weight information to the computer 102, to allow the computer 102 to reconcile transactions by comparing the actual total weight of the items placed in bags against expected weight of the items entered into the transaction. The terminal 100 also includes a check processing module 122, suitably within the terminal 100. A customer may suitably submit a check by placing the check into a slot 123 within the check processing module 122. The check processing module 122 includes a combination magnetic ink reader and printer 124, a conventional ink printer 126 and a camera 130. When a check is inserted into the slot 123, a transport mechanism may suitably transport it along a path such as the path 131 that will bring it into proper position for processing by the reader and printer 124, and the conventional ink printer and for image capture by the camera 130, and will then bring it back to the slot 123 for return to the customer. As an alternative to being transported back to the slot for return to the customer, the check may follow a path that will bring it into position for processing and image capture, and then to a receptacle for retention within the terminal 100. The transport mechanism is not shown in order to avoid obstructing the view of the other elements of the check processing module 122, but may suitably include electromechanical devices such as rollers, pneumatic devices or other mechanisms adapted to automatically transport physical objects such as checks whose size, shape and weight can be expected to fall within a standard and known range.

The check processing module 122 communicates with and operates under the control of the computer 102. In addition, the terminal 100 includes a security camera 132, which may be used to provide a live video feed to a cashier or security guard at a remote station and may alternatively or in addition be used to capture still or moving images that may be stored using the computer 102 and transferred as needed to employees at remote stations.

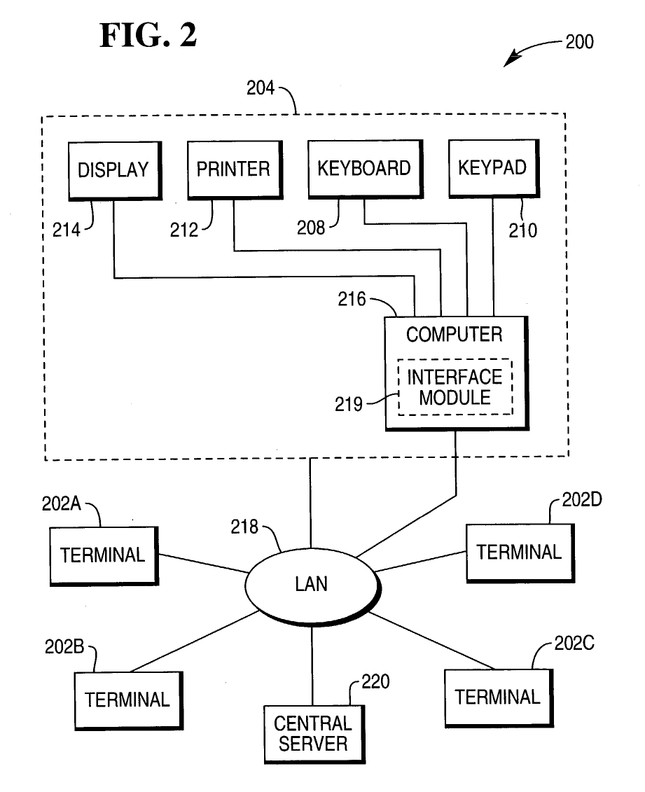

A customer conducts a transaction at the tenminal 100 by activating the terminal 100, suitably by making an appropriate selection by touches on the display 106, and scans or otherwise enters items into the transaction following instructions presented on the display 106. During the transaction, the customer may also scan or otherwise enter a preferred customer identifier, from a preferred customer card, for example, by scanning a barcode on the card, swiping a magnetic stripe on the card or entering a number on the card. Preferred customer cards are often used to track customer visits and purchases and to tailor discounts and offers to customers based on their purchase history. Preferred customer cards can also be used as identification for tendering checks, and permit a retailer to build and retrieve a customer record detailing a customer's check cashing history and which can be examined to determine whether or not the customer has previously tendered bad checks. Such a customer record can be stored on a central server such as the server 220 of FIG. 2. Alternatively, a customer record can be built using the customer's checking account number as a reference. Records of transactions involving the same checking account number can assembled to form a record of transactions involving that checking account. The customer record can include the number of transactions and each transaction record can include a notation as to whether the customer tendered a bad check in settlement of the transaction. It will be recognized that the customer record need not be based exclusively on information collected by the terminal 100, instead, the terminal 100 and any other self service or cashier operated transaction devices may all contribute transaction information to the customer record. All such devices may obtain access to the customer record when there is a need to use the information to decide whether to approve a transaction.

When the customer wishes to conclude the transaction and tender payment, he or she makes an appropriate selection. The customer is then presented with the transaction total, and may be presented with options to receive cash back from a check or debit card transaction.

If it is desired to pay by using cash or a credit or debit card, the customer makes an appropriate selection and tenders payment accordingly. If the customer wishes to pay by check, he or she makes an appropriate selection, prepares the check, and places it into the slot 123 in the check processor 122. Depending on the design and programming of the terminal 100, one of a number of different procedures may be followed in order to approve the check and settle the transaction. Each of the procedures involves creating a check record comprising information to be used in deciding whether to approve the transaction. This information may include check information collected from the check and may also include additional information relating to the check, the account on which the check was drawn and the customer. The different procedures that may be implemented accommodate different choices that may be made about the steps to be taken in collecting information from the check and in presenting the check for payment.

A first exemplary procedure that may be followed is a multiple stage presentation. Depending on the design and programming of the terminal 100, or choices made by the customer, the customer may insert a blank check into the check processing module 122, or may fill out the check except for the signature and insert the check into the check processing module 122. In either case, a check record is opened following the initial placement of the check into the check processing module 122. The bank routing number and account number on the check are read using the magnetic ink reader and printer 124. In addition, the check processing module 122 may read any machine readable security features present on the check. If the security features indicate that the check may be altered or counterfeit, a cashier may be notified by sending an appropriate notice to a cashier's station such as the station 204 illustrated in FIG. 2 and discussed below. On the other hand, if the security features are determined to be authentic, the authenticity of the features can be used to help provide assurance that the check is genuine.

If a blank check has been inserted into the check processing module 122, the check processing module 122 uses the conventional ink printer 126 to fill out the check appropriately, printing the date, payee and amount in appropriate locations on the check. Whether the customer has filled out the check or the check processing module 122 has printed the required information on the check, the transaction amount is printed on the check using the magnetic ink reader and printer 124. The transaction amount is known because the transaction total has been presented to the customer and accepted. If the customer has filled out the check, it is presumed that the customer has written the check for the amount presented as the transaction total, representing the purchase amount and any cash back amount that has been chosen by the customer. If desired, an authenticating code may be printed on the check using the magnetic ink reader and printer 124. The check record is updated to include the routing number and account number, the transaction amount, and any other information that has been entered on the check and which it is desired to include in the check record. The check record may also be updated to include the presence and validity of any security features noted on the check. The check record is stored by the computer 102. The check is then returned to the customer for signature.

Once the check has been signed, the customer again places the check into the check processor 122. The check is authenticated to make sure that it is the same check that has previously been inserted. This authentication may be accomplished by reading information on the check corresponding to information in the check record, including, for example, the bank routing number, account number, check number and the previously printed transaction amount using the magnetic ink reader and printer 124. If the check record includes an authenticating code previously written onto the check, this code may be read by the reader and printer 124, giving a very high degree of confidence that the check presented is the same check as previously presented. The information read from the check is compared against the information in the check record and stored using the computer 102, and examined to determine whether or not it matches. If the authentication fails, a cashier may be notified by sending an appropriate signal to a cashier's station such as the station 204 illustrated in FIG. 2 and discussed further below.

After the check has been authenticated by reading magnetic ink information, an image of the check is captured using the camera 130. In addition, if a retailer operating the terminal 100 is suitably equipped and subscribes to the appropriate services, a query including the routing number, account number and amount of the check may be relayed to a financial institution in order to determine whether or not the customer's account has sufficient funds to cover the check. Such a query may be prepared by the computer 102 and presented to a central server such as the server 220 of FIG. 2, through the local access network 218 of FIG. 2. The central server 220 may suitably be able to communicate with an external service such as a clearinghouse in order to obtain account information. In such a case, the answer to the query, that is, the notation as to whether or not the customer's account has sufficient funds to cover the check, is added to the check record. The check record, including the amount of the check, the image of the check and any information concerning the sufficiency of funds in the customer's account, is then transmitted to the cashier's station. A cashier may then examine the check record and approve the transaction or request further information, such as presentation of identification. The cashier may also, of course, leave the cashier's station and approach the customer in order to discuss the transaction, as might be advisable if the check appeared to be fraudulent, stolen or otherwise deficient or questionable in some respect.

If the casher requests identification, such a request will appear on the display 106, and the customer may place an identification document such as a driver's license into the check processor 122, where an image of the document may be captured by the camera 130. The camera 130 transmits an image of the document to the cashier's station for examination by the cashier. In addition, a request may be displayed asking the customer to stand within the field of view of the security camera 132. An image of the customer is captured and transmitted to the cashier along with the image of the identification document, allowing the cashier to confirm that the picture, if any, on the identification document, matches the appearance of the customer.

As an alternative or in addition to presenting the document for visual inspection, the customer may be requested to enter a document number, such as a driver's license number, using the display 106. The request to enter the document number may be presented automatically by the terminal 100 when the customer chooses to pay by check, and the document number entry can be made without a need for intervention by the cashier. The document number may be indexed to a customer history such as a record of bad checks tendered by the customer, or a more elaborate customer record detailing a customer's transaction history. Such a record may be maintained by the retailer or by a data recording service, such as a credit bureau. If the customer's record indicates an unacceptable history of bad checks, the cashier is notified and can intervene as appropriate.

Once the cashier has approved the transaction, the computer 102 may suitably associate the image of the check with the information read from the check and submit the financial information for processing. The submission of the information may suitably take place immediately.

Alternatively, submission of the financial information may take the form of storage of the information for submission as part of a batch transaction, in which a large number of transactions are submitted at the same time. For example, financial information for all check transactions conducted at a retail location may be stored for batch processing at a later time, and then financial information for all these transactions may be submitted to a bank at the end of the business day or at another convenient time.

After the transaction has been completed and accepted, the check may be returned to the customer. The conventional ink printer 126 may print a “void” or “paid” notice on the check, and the check is then passed out of the terminal 100 where it may be removed by the customer. In addition, any cash or change to be returned to the customer is delivered to the coin return 112 and the bill return 114. At this point, the transaction is completed and the customer may leave with his or her purchases.

It will be noted that check truncation, that is, the electronic collection and processing of the check information in order to receive payment while returning the actual physical check to the customer, is not required. The customer may submit check using the terminal 100, and upon approval of the check, the terminal 100 may retain the check for later deposit to a bank. Retention of the check is possible as a part of either of the procedures described above, that is, the case in which the customer submits an unsigned check, for example a blank check to be filled out by the terminal 100, and then receives the check for signature, or the case in which the customer fills out the check in its entirety before placing it in the check processor 122.

As an alternative to first placing the check into the check processor 122, receiving the check after the information has been read and then signing the check and again placing it in the check processor 122, the customer may simply fill out the check in its entirety, including signature, before placing it in the check processor 122. Reading and processing of information, as well as transmitting of information to the cashier, is performed as described above.

FIG. 2 illustrates a retail checkout system 200 according to an aspect of the present invention. The system 200 includes a plurality of self service checkout terminals 202A-202D, each of which may suitably be similar to the terminal 100 of FIG. 1. The system 200 also includes a cashier's station 204 to allow a cashier to supervise activity at each of the terminals 202A-202D, in order to provide customer assistance when needed and to prevent fraud. The cashier's station 204 includes a keyboard 208, a keypad 210, a printer 212 and a display 214.

The cashier's station 204 also includes a computer 216, for controlling the operation of the station 204 and facilitating communication between the station 204 and the terminals 202A-202D. Communication between the station 204 and the terminals 202A-202D may be carried out over a local area network 218, allowing communication between the computer 216 and onboard computers in the terminals 202A-202D. The computer 216 may include an interface module 219 to allow communication over the network 218, thus allowing the cashier station 204 to receive transaction information from the terminals 202A-202D and to transmit cashier entries for control of the transaction to the terminals 202A-202D. The computer 216, as well as computers hosted by each of the terminals 202A-202D, may also connect to a central server 220, which can communicate with the cashier station 204 and the terminals 202A-202D in order to provide operational services maintained by a retailer operating the system 200. Such services may include price lookup and inventory control. In addition, the server 220 may provide access to external services, such as credit bureau reports and account information, which can be used in evaluating checks and other instruments tendered by a customer.

When a customer wishes to pay by check at, for example the terminal 202A, the customer makes an appropriate selection and proceeds to fill out and submit the check, following instructions provided at the terminal 202A. The customer may place the check into a check processing module similar to the module 122 of FIG. 1. The terminal 202A creates a check record including information read from the check, as well an image of the check. The terminal 202A transmits the check record to the cashier station, where the image of the check, as well as other information relevant to verifying the check, is displayed using the display 214. The cashier examines the image of the check and the other information in the check record and either approves the transaction or takes other appropriate action. Such action may include, for example, disapproving the transaction, sending a message to the customer such as a request to submit identification or requesting that the customer come to the cashier station 204 to allow direct examination of the check. If the cashier asks to see the check, the terminal 202A will be directed to return the check to the customer. If the cashier asks to see identification, the customer will be directed to place an identification document in a field of view of a camera belonging to the terminal 202A. This may suitably be accomplished by placing the document into a check processing module such as the check processing module 122 of FIG. 1, but may also be accomplished by placing the document within the field of view of other cameras, such the security camera 132 of FIG. 1, with which the terminal may be equipped. An image of the identification document will be transmitted to the display 214, and the cashier can examine the document and decide whether or not to approve the transaction.

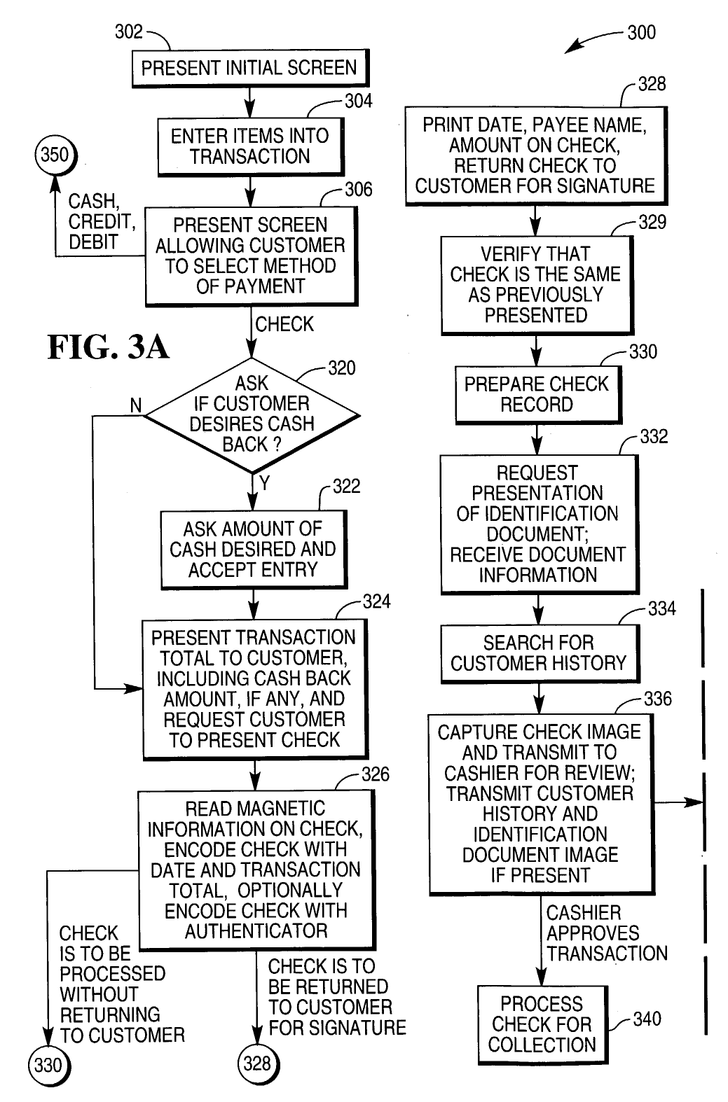

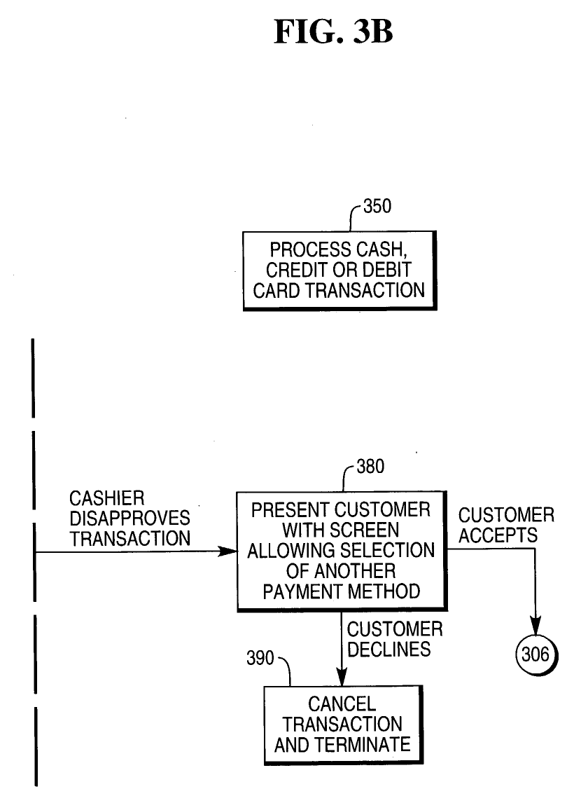

FIGS. 3A and 3B illustrate a process 300 of conducting a self service retail transaction according to the present invention. At step 302, upon activation of a terminal by a customer, an initial screen is presented directing the customer to make selections and perform operations such as scanning and data entry in order to enter items into a transaction. At step 304, a transaction record is created and updated based on upon entries and selections by a customer. The transaction record may suitably include identification and prices of products to be purchased, as well as a cumulative total of the transaction. At step 306, upon a selection by a customer to conclude the transaction and tender payment, a screen is presented to the customer inviting the customer to select a method of payment. If the customer chooses to pay by cash, credit card or debit card, the process proceeds to step 350 and cash is accepted and change issued, or a credit or debit card transaction is processed, depending on the selection made by the customer and inputs made by the customer. If the customer chooses to pay by check, the process proceeds to step 320.

At step 320, upon a customer selection to of the option to pay by check, a display is presented to the customer inquiring if the customer wishes cash back from the transaction and the customer answer is received. If the customer answers in the affirmative, the process proceeds to step 322. Otherwise, the process skips to step 324. At step 322, the customer is asked to make an entry indicating the amount of cash desired. Upon entry by the customer indicating the amount desired, the process proceeds to step 324.

At step 324, a total is presented to the customer indicating the transaction total, including the amount of cash to be returned, if any, and the customer is requested to present a check for the indicated amount. Depending on the procedure to be followed, the customer may be advised to fill out and sign the check before presentation or may be instructed to insert a blank, unsigned check to be filled out by the terminal and advised that the check will be returned for signature after initial reading. Upon presentation of the check by the customer, the process proceeds to step 326, the magnetically coded information on the check is read, and the check is magnetically encoded with the date and the transaction total and may be encoded with an authenticating code to be used to identify the check if it is resubmitted.

If the customer has not been instructed to wait for initial submission and return of the check before signing, the process skips to step 330. If the customer has been instructed to wait for initial submission and return of the check, the process proceeds to step 328 and the check is completed with the payee name, date and transaction total and returned to the customer for signature. Upon resubmission of the check by the customer, the process proceeds to step 329 and reads the magnetic information encoded on the check in order to verify that the check is the same one that was previously submitted. The process then proceeds to step 330.

At step 330, a check record is prepared, comprising the routing number, account number, check number and amount of the check. At optional step 332, the customer is requested to present an identification document, such as driver's license. Presentation includes entry of a document number, for example by manual entry on a keypad or touch screen display, or swiping of the document using a card reader, as well as submission of the document for capture of an image of the document. Presentation may also include allowing capture of an image of the customer for comparison with the image of the identification document. If optional step 332 has been performed, step 334 is also performed and the document number is used to search for a customer history, including a bad check record. At step 336, an image of the check is captured and associated with the check record, and the check record and the image of the check are transmitted to a cashier for review. If steps 332 and 334 have been performed, the identification document image and a summary of the customer history are also transmitted to the cashier. The cashier may approve the transaction, disapprove the transaction or request additional information or documentation from the customer. Upon a selection by the cashier to approve the transaction, either initially or after requesting and receiving additional information, the process proceeds to step 340. Upon a selection by the cashier to disapprove the transaction, the process proceeds to step 380 and the customer is presented with a screen offering the opportunity to choose another method of payment. If the customer indicates acceptance, the process returns to step 306. If the customer indicates refusal, the process proceeds to step 390 and the transaction is voided.

At step 340, the check is processed for collection. This may be accomplished by submitting the check record to a central location or server for electronic submission, in which case the paper check submitted by the customer is marked “voided” or “paid” and returned to the customer. Alternatively, the check is retained for physical collection and submission for payment.

While the present invention is disclosed in the context of various presently preferred embodiments, it will be recognized that a wide variety of implementations may be employed by persons of ordinary skill in the art consistent with the above discussion and the claims which follow below.

I claim:

1. A customer self service terminal, comprising:
a customer interface for receiving inputs from a customer to allow the customer to conduct a transaction, the customer interface allowing the customer to issue and receive commands and information in order to complete the transaction; and
a check processing module for authenticating and verifying a check received from a customer in order to allow the customer to make payment and conclude the transaction, the check processing module being operative to capture an image of the check for transmittal to a cashier in order to allow the cashier to verify the check.

2. The terminal of claim 1, wherein the check processing module comprises a magnetic ink reader for reading information magnetically encoded information on the check and a magnetic ink printer for printing magnetically coded information onto the check.

3. The terminal of claim 2, further comprising a computer operative to create a check record for a check submitted by a customer as payment for a transaction, the check record including magnetic information read from the check, the date and amount of the transaction and the captured image of the check and to transmit the check record for processing.

4. The terminal of claim 3, wherein the terminal is operative to receive identification document information submitted by a customer, the identification document information including a document number associated with the identification document, to retrieve a customer record associated with the number and to transmit the identification document information and the customer record to the cashier for examination.

5. The terminal of claim 4, wherein the terminal is operative to capture an image of an identification document submitted by the customer and to transmit the image to the cashier for examination.

6. The terminal of claim 5, wherein the computer is operative to present a query asking whether the balance of an account identified in the check record is sufficient to pay the check associated with the check record and to notify the cashier if the balance is insufficient.

7. The terminal of claim 6, wherein the terminal is operative to capture an image of the customer and to transmit the image of the customer to the cashier along with the image of the identification document.

8. The terminal of claim 7, wherein the computer is operative to electronically submit the check information included in the check record in order to process the check for payment and wherein the check module is operative to void the check and return it to the customer upon such submission.

9. A cashier station for receiving transaction information from a self service terminal, in order to allow a cashier to monitor a transaction conducted at the self service terminal, comprising:
an external interface for receiving the transaction information and transmitting cashier entries for controlling the transaction; and
a cashier interface for presenting the transaction information to the cashier, the transaction information including a captured image of a check presented by the customer as payment for a transaction, the cashier interface being further operative to receive entries from the cashier for controlling the transaction and to pass the entries to the external interface for transmission to the terminal.

10. The cashier station of claim 9, wherein the cashier entries may include a request from the cashier for presentation of an identification document and wherein the cashier station is operative to receive a customer record associated with the identification document and a captured image of the identification document, for examination by the cashier.

11. A transaction processing system, comprising:
a plurality of self service terminals, each terminal comprising a customer interface for receiving inputs from a customer to allow the customer to conduct a transaction, the customer interface allowing the customer to issue and receive commands and information in order to complete the transaction and a check processing module for authenticating and verifying a check received from a customer in order to allow the customer to make payment and conclude the transaction, the check processing module being operative to capture an image of the check, each terminal being further operative to prepare a transaction record including the image of the check for transmittal to a cashier; and
a cashier station communicating with each of the terminals, the cashier station being operative to receive the transaction record from each of the terminals, the cashier station being operative to display the check image included in the transaction record to allow a cashier to verify the check, the cashier station being further operative to receive entries from the cashier for controlling the transactions and to transmit control instructions to the terminals based on the entries.

12. The system of claim 11, wherein each terminal is operative to create a check record for a check submitted by a customer as payment for a transaction, the check record including magnetic information read from the check, the date and amount of the transaction and the captured image of the check and to transmit the check record to the cashier station to allow the cashier to verify the check.

13. The system of claim 12, wherein each terminal is operative to prepare a query for presentation to a remote server in order to determine whether the balance of an account identified in the check record is sufficient to pay the check associated with the check record, to receive the answer to the query and to add the answer to the check record before transmitting the check record to the cashier station.

14. A method of self service transaction processing, comprising the steps of:
receiving customer inputs to enter items into a transaction and to conclude the transaction and tender payment;
receiving a selection from a customer to pay by check;
reading information from a check submitted by the customer;
preparing a check record including the information read from the check and the total amount of the transaction;
capturing an image of the check and adding the image to the check record; and
presenting the check record to a cashier at a remote cashier station to allow the cashier to use the check record to determine whether to approve or disapprove the transaction.

15. The method of claim 14, wherein the step of preparing the check record is followed by magnetically encoding the transaction amount and date of the transaction on the check.

16. The method of claim 15, further including the step of requesting submission of an identification document by the customer, receiving identification document information from the customer and adding the identification document information to the check record.

17. The method of claim 16, wherein the step of receiving the identification document information includes receiving an identification document number and retrieving a customer record associated with the identification document number, and wherein the step of adding the identification document information to the check record includes adding the customer record to the check record.

18. The method of claim 17, wherein the step of receiving the identification document information includes capturing an image of the identification document.

19. The method of claim 18, wherein the step of receiving the identification document information is followed by a step of capturing an image of the customer and wherein the image of the customer is added to the check record to allow comparison with the image of the identification document.

20. The method of claim 19, wherein the step of preparing the check record includes a step of presenting a query asking whether the balance of an account identified in the check record is sufficient to pay the check associated with the check record and including in the check record a notation as to whether or not the balance is sufficient.

21. The method of claim 19, further including a step of electronically submitting check information from the check record to a clearinghouse for payment.
